(19) United States
(12) Patent Application Publication
(10) Pub. No.: US 2006/0125420 A1
(43) Pub. Date: Jun. 15, 2006

(54) Candle emulation device

(76) Inventors: Michael Boone, Los Angeles, CA (US); Kurt Campbell, Cambridge, MA (US); Mark Medley, Covina, CA (US); David Zito, Pasadena, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/294,930

(22) Filed: Dec. 6, 2005

Related U.S. Application Data
(60) Provisional application No. 60/633,496, filed on Dec. 6, 2004.
(60) Provisional application No. 60/667,717, filed on Mar. 31, 2005.
(60) Provisional application No. 60/697,610, filed on Jul. 8, 2005.

(51) Int. Cl. H05B 37/02

(52) U.S. Cl. 315/291

(57) ABSTRACT

According to one embodiment of the invention, a candle emulation device comprises a light source, a light source controller and an optional fragrance-release mechanism. The light source controller is coupled to the light source and is adapted to control the light source in order to produce a lighting effect that emulates lighting from a candle flame. The fragrance-release mechanism is adapted to release a fragrance into air surrounding the candle emulation device.

### CROSS-REFERENCES TO RELATED APPLICATIONS

This application claims the benefit of priority on U.S. Provisional Application No. 60/633,496 filed Dec. 6, 2004, U.S. Provisional Application No. 60/667,717 filed Mar. 31, 2005 and U.S. Provisional Application No. 60/697,610 filed Jul. 8, 2005.

### FIELD

Embodiments of the invention relate to the field of lighting, in particular, to candle emulation.

### GENERAL BACKGROUND

For centuries, wax candles have been used to provide lighting for all types of dwellings. Over the last thirty years, however, wax candles have mainly been used as decorative lighting or as subdued lighting for mood-setting purposes. For instance, restaurants use wax candles as decorations in order to provide a more intimate setting for their patrons. Individuals purchase wax candles for placement around their home to provide a festive or relaxing environment for their guests.

There are a few disadvantages with wax candles. One disadvantage is that they are costly to use when considering operational costs ($/usage time). In addition to their high cost, wax candles with open flames pose a risk of fire when left unattended for a period of time. These candles also pose a risk of harm to small children who do not understand the dangers of fire.

Accordingly, for cost savings and safety concerns, in certain situations, it would be beneficial to substitute a wax candle for a candle emulation device. Unfortunately, most candle emulation devices do not accurately imitate the lighting effect of a flickering candle, namely a realistic flickering light pattern. For usage by restaurants, this may leave an unfavorable impression by patrons of a restaurant. For usage at home, it may not provide the overall mood-setting effect that the user has tried to create.

Also, candle emulation devices do not employ a fragrance-release mechanism to provide different aromatic scents throughout the surrounding environment.

### BRIEF DESCRIPTION OF THE DRAWINGS

The invention may best be understood by referring to the following description and accompanying drawings that are used to illustrate embodiments of the invention.

FIG. 1A is an exemplary block diagram of a candle emulation device employing the present invention.

FIGS. 1B-1D are exemplary embodiments of the fragrance-release mechanism of FIG. 1A.

FIG. 2A is a first exemplary embodiment of the candle emulation device of FIG. 1A.

FIG. 2B is a second exemplary embodiment of the candle emulation device of FIG. 1A.

FIG. 2C is a third exemplary embodiment of the candle emulation device of FIG. 1A.

FIG. 2D is a fourth exemplary embodiment of the candle emulation device of FIG. 1A.

FIG. 3A is a first exemplary embodiment of a light source represented as an incandescent bulb featuring staggered electrical feedthroughs and operating as a light source for the candle emulation device of FIG. 1A.

FIG. 3B is an exemplary embodiment of a base of the incandescent bulb of FIG. 3A.

FIG. 3C is a second exemplary embodiment of a light source represented as an incandescent bulb.

FIG. 3D is an exemplary embodiment of independently controlled filament construction for the incandescent bulb of FIG. 3A or 3C.

FIG. 3E is a first exemplary schematic diagram of a multi-filament incandescent bulb of FIG. 3A or 3C with each of the four filament segments independently controlled.

FIG. 3F is a second exemplary schematic diagram of a multi-filament incandescent bulb of FIG. 3A or 3C with two of the filament segments independently controlled.

FIG. 3G is a third exemplary schematic diagram of a multi-filament incandescent bulb of FIG. 3A or 3C.

FIG. 3H is a fourth exemplary schematic diagram of a multi-filament incandescent bulb of FIG. 3A or 3C with each of the four filament segments independently controlled.

FIG. 3I is a fifth exemplary schematic diagram of multi-filament incandescent bulb of FIG. 3A or 3C with a reduced number of electrical lead lines.

FIG. 4A is an exemplary embodiment of a dimmer switch adapted to control the light source in order to emulate a flickering candle.

FIG. 4B is a first exemplary embodiment of the internal components forming the dimmer switch of FIG. 4A.

FIG. 4C is a second exemplary embodiment of the dimmer switch adapted to control the light source in order to emulate a flickering candle.

FIG. 5 is an exemplary embodiment of an input power waveform provided to the dimmer switch of FIG. 4B or 4C.

FIG. 6 is a first exemplary embodiment of the light source controller operating with the dimmer switch to control the light source in order to emulate a flickering candle and the signaling received and produced by the light source controller.

FIG. 7 is a first exemplary embodiment of the operations performed by the power signal modulated clock of FIG. 6.

FIG. 8A is an exemplary embodiment of the components associated with the power signal modulated clock of FIG. 6.

FIG. 8B is a second exemplary embodiment of the operations performed by the power signal modulated clock as shown in FIGS. 6 and 8A.

FIG. 9 is an exemplary embodiment of an alternative light source for the candle emulation device of FIG. 1A.

FIGS. 10A-10B collectively illustrate an exemplary embodiment of an assembly of one type of candle emulation device.

FIG. 11 is an exemplary embodiment of a detailed view of the housing of a Tea light 1000 illustrated in FIGS. 10A and 10B.

FIGS. 12A-12B collectively are an exemplary embodiment of the assembly of FIG. 9.

FIG. 12C is an alternative embodiment of the lighting elements of the assembly of FIG. 9.

FIG. 12D is an alternative embodiment of an assembly adapted for a candle emulation device such as a Tea light.

FIG. 13 is an exemplary block diagram illustrating mode switching controlled by light source controller 120 of FIG. 1A.

### DETAILED DESCRIPTION

Herein, certain embodiments of the invention relate to an apparatus, logic and method for electrically emulating lighting from a candle flame. For instance, one aspect is taking a phase controlled, time-varying (e.g., periodic) power waveform, such as an output of a dimmer switch for example, and applying a fixed or adjusting pulse width modulated frame that is compressed within the available power or voltage in order to control a light source such as an incandescent light bulb for example.

Herein, certain details are set forth below in order to provide a thorough understanding of various embodiments of the invention, albeit the invention may be practiced through many embodiments other than those illustrated. Well-known components and operations are not set forth in detail in order to avoid unnecessarily obscuring this description.

In the following description, certain terminology is used to describe features of the invention. For example, the term “lighting fixture” is generally defined as any device that provides illumination based on electrical input power, where as described below, a “candle emulation device” is merely a lighting fixture providing illumination that emulates the lighting effect of a candle. Examples of various types of lighting fixtures include, but are not limited or restricted to a lamp, a table lamp featuring a pillar or tapered candle housing, a sconce, chandelier, lantern, a night light or the like. Moreover, a “component” or “logic” is generally defined as hardware and/or software, which may be adapted to perform one or more operations on an incoming signal. Examples of types of incoming signals include, but are not limited or restricted to power waveforms, clock, pulses, or other time-varying signals. Also, the term “translucent material” is generally defined as any composition that permits the passage of light. Most types of translucent material diffuse light. However, some types of translucent material may be transparent in nature.

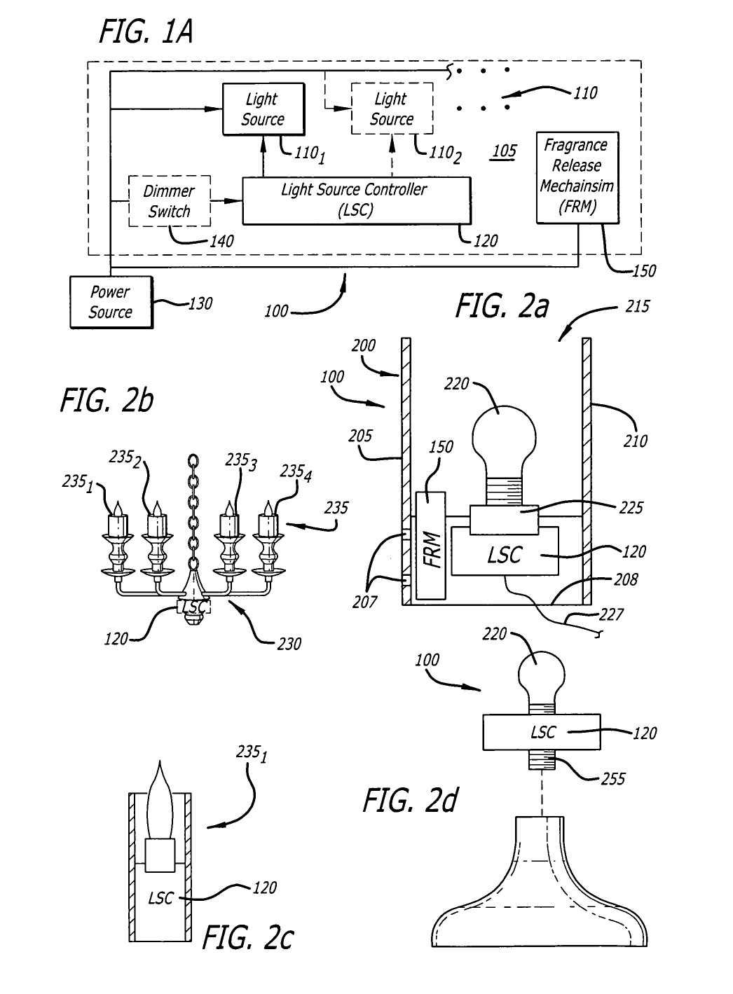

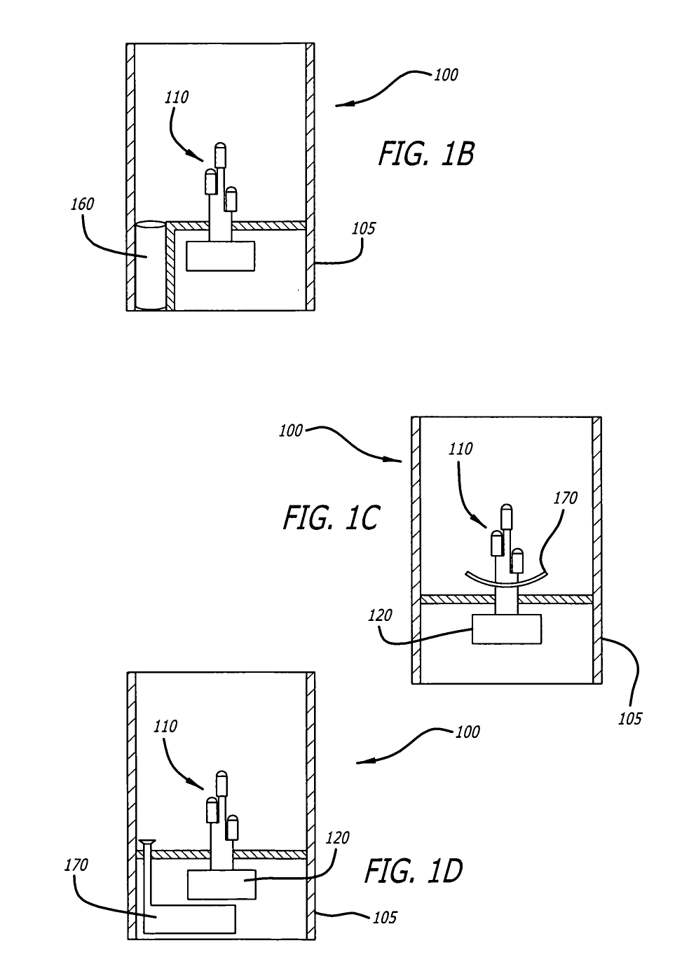

Referring to FIG. 1A, an exemplary block diagram of a candle emulation device employing the present invention is illustrated. Candle emulation device 100 comprises one or more light sources 110₁, . . . , and/or 110_{N} (N≧1), generally referred to as “light source 110,” controlled by a light source controller (LSC) 120 positioned within a housing 105.

Light source 110 and light source controller 120 are supplied power by a power source 130, such as line voltage (e.g., ranging between approximately 110-220 volts in accordance with U.S. and International power standards, such as 110 voltage alternating current “VAC” at 50 or 60 Hertz “Hz”, 220 VAC at 50 or 60 Hz, etc.) supplied from a wall socket. Although not shown, the line voltage may be converted to an acceptable voltage level for use Alternatively, power source 130 may be any number of other power supplying mechanisms such as a transformer that supplies low voltage power (12 VAC), a battery, or any type of rechargeable power source for example. As illustrated, power source 130 may be situated external to housing 105 of candle emulation device 100 or, in certain embodiments, may be placed internally therein.

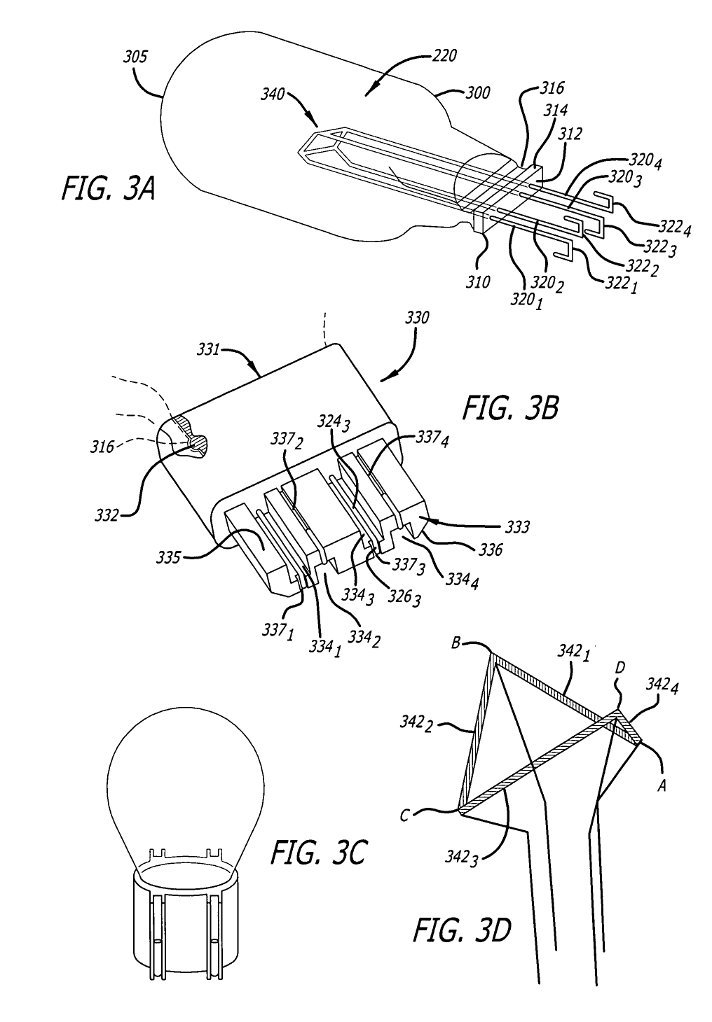

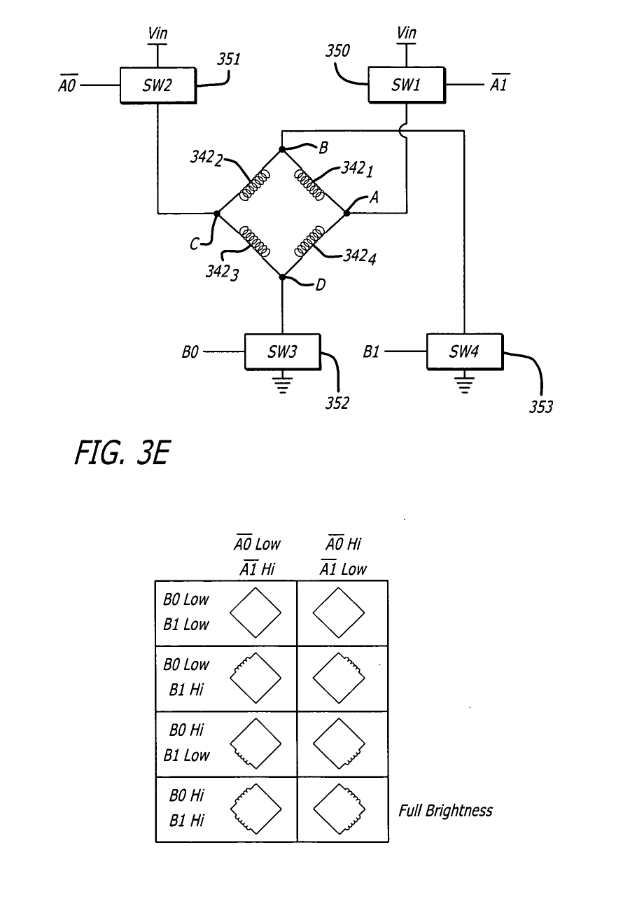

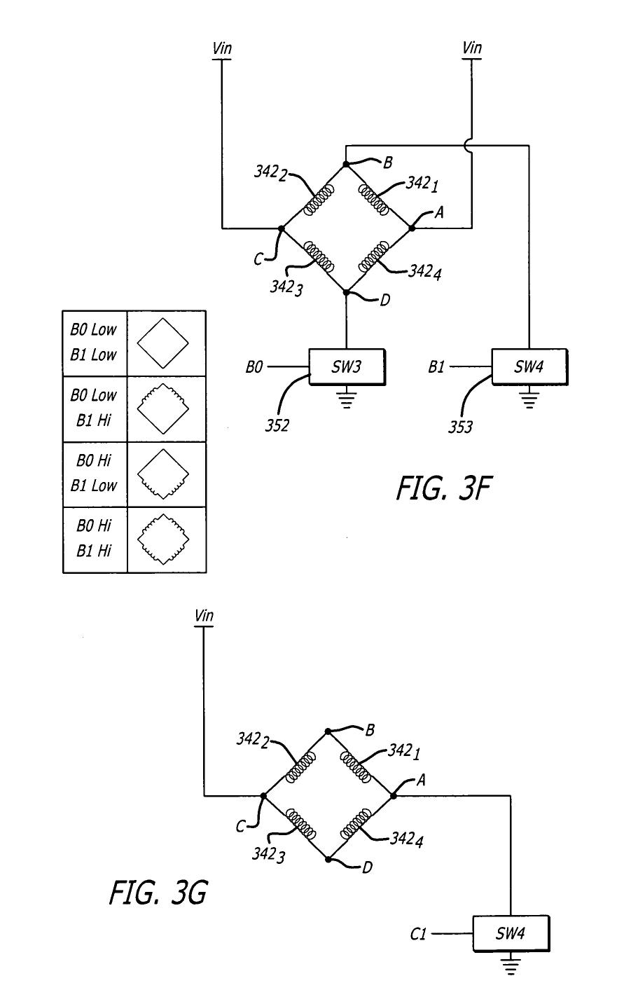

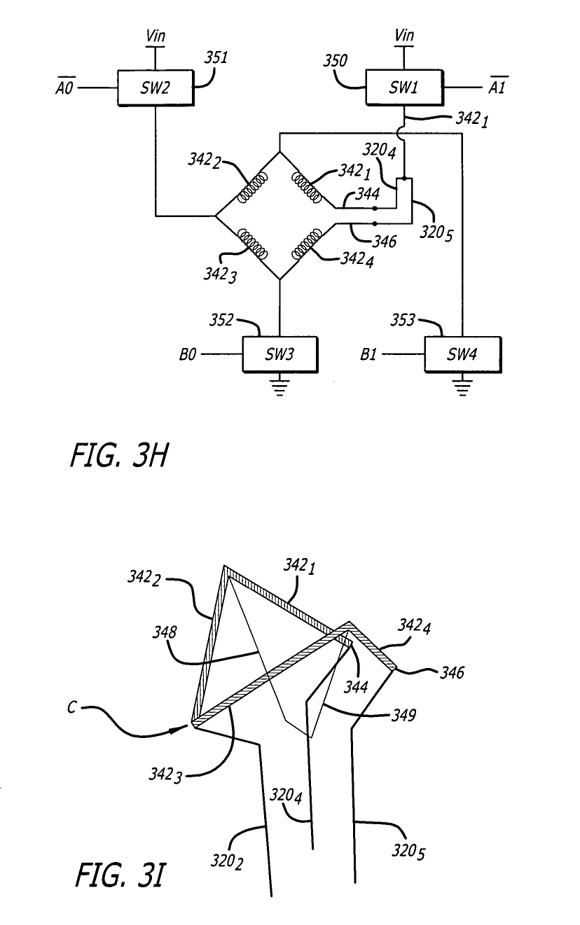

According to one embodiment of the invention, each light source 110 is a single incandescent light bulb that may be electrically coupled to light source controller 120. Exemplary light sources are illustrated in FIGS. 3A-3I and described below.

Although not shown in FIG. 1A, according to one embodiment of the invention, light source controller 120 comprises a circuit board featuring power regulation and conditioning logic, candle emulation control logic and driver logic. The power regulation and conditioning logic is configured to provide regulated, local power from an unregulated input power supplied by power source 130. The regulated local power is supplied to other components within light source controller 120 such as the candle emulation control logic and the driver logic. The candle emulation control logic is adapted to create a realistic candle lighting pattern. The driver logic is adapted to mechanically connect with and drive (activate/deactivate) light source 110. The operation of these components will be described in detail below.

Alternatively, it is contemplated that light source controller 120 may comprise multiple circuit boards with a primary circuit board adapted for power regulation and supplying regulated power to one or more secondary circuit boards responsible for controlling light source 110. As one example, a secondary circuit board may be adapted to control a single light source 110₁ or multiple light sources 110₁ and 110₂. As another example, one secondary circuit board may be adapted to control a light source 110₁ while another secondary circuit board may be adapted to control a different light source 110₂, and the like.

It is contemplated that light source controller 120 may be adapted with a first connector designed so that light source 110 may be removed and replaced with a different light source. Similarly, light source controller 120 may be adapted with a second connector designed so that either light source controller 120 or power source 130 may be removed and replaced as needed.

It is further contemplated that a control unit 140, optionally shown by dashed lines, may be adapted to cooperate with light source controller 120 to control the illumination of candle emulation device 100 of FIG. 1A. For such an embodiment, control unit 140 is a dimmer switch 140 may be situated within housing 105 or external to housing 105. It is contemplated, however, that control unit 140 may be a light switch, a photocell, a timer or any unit for controlling an illumination output of light source 110.

As shown, a fragrance-release mechanism 150 may be implemented within housing 105. Fragrance-release mechanism (FRM) 150 comprises a material featuring a fragrance where particles of the material forming the fragrance are emitted. Normally, such emission may be causes by the movement of air over the material and through one or more openings in housing 105 of candle emulation device 100 as shown in FIG. 2A. The moving air carries fragrance particles. Of course, it is contemplated that the movement of air may be magnified through forced ventilation (e.g., use of fan) or by use of heat.

According to one embodiment of the invention, as shown in FIG. 1B, the material may be a cartridge 160 filled with a liquid (e.g., aqueous-based solution, scented oil, etc.) that emits the fragrance in a gaseous form. Cartridge 160 is inserted within housing 105 and maintained therein. Cartridge 160 may be permanently installed or may be removable to receive replacement cartridges as needed. As an optional feature, the liquid can be heated to accelerate the emission of the fragrance by increasing the rate of gaseous discharge of fragrance particles in gaseous form.

Alternatively, according to another embodiment of the invention, the material may be a solid that is placed within housing 105 (not shown). The gaseous emission of the fragrance is conducted under ambient temperatures, where degradation of the material and emission of the fragrance may occur more slowly than when the material is in a liquid form. Of course, the solid fragrance material may be heated and placed into a liquid form to accelerate emission of the fragrance. The solid insert may be permanently installed within housing 105 or in a replaceable form factor.

As yet another alternative embodiment, as shown in FIGS. 1C-1D, the material having a fragrance is placed into a storage device 170 within housing 105. Storage device 170 may be adapted to retain the material in a liquid form. The liquid is poured into storage device 170 and exposed to the air, where gaseous emissions of the fragrance occur under ambient temperatures. Where the material is a solid, the solid is placed in storage device 170 and exposed to air. Examples of storage device 170 includes, but is not limited or restricted to a tray positioned above light source controller 120 as shown in FIG. 1C or a container shown in FIG. 1D. Of course, the material may be heated to accelerate emissions of the fragrance. Such heating may be accomplished by the light source or by a separate heating unit.

Referring now to FIG. 2A, a first exemplary embodiment of candle emulation device 100 of FIG. 1A is shown. Candle emulation device 100 is illustrated as one type of lighting fixture, namely a table lamp including a pillar or tapered candle housing 200 featuring translucent side walls 205 and 210 as well as an uncovered top opening 215. Light from light source 110, represented as an incandescent light bulb 220 for this embodiment, casts shadows replicating lighting from a candle flame. Translucent side walls 205 and 210 may form part of a plastic scented or unscented candle shell having a smooth, textured drippy or otherwise aesthetically pleasing outer surface. For instance, the candle shell may be made of a polyresin for durability, and optionally the polyresin may be mixed with a scented material. Alternatively, translucent sidewalls 205 and 210 may be any other type of translucent material such as a natural or synthetic cloth, paper, plastic, glass, or other suitable material.

A connector 225 is configured as an interface for mating with a complementary base of incandescent light bulb 220, which provides electrical connectivity between incandescent light bulb 220 and light source controller 120. A detailed illustration of one embodiment of the base of incandescent light bulb 220 is shown in FIG. 3B, where connector 225 would be configured as a socket.

Normally, the power source would be featured outside of pillar candle housing 200 and power supplied via a power line 227 which would be converted (e.g. regulated with conditional for components within candle emulation device 100. However, it is contemplated that power source 130 could be implemented within housing 200 as an alternative embodiment.

According to one embodiment of the invention, fragrance-release mechanism 150 is positioned to allow the fragrance to escape to the ambient environment surrounding housing 200. For instance, fragrance may escape through top opening 215 and/or one or more openings 207 in side walls 205 and/or 210. As an optional feature, the size of opening(s) 207 may be adjustable such as through rotation of a base 208 supporting translucent sidewalls 205 and 210. In general, a larger size for opening 207 provides greater air circulation and a greater amount of fragrance to be released.

Referring to FIG. 2B, a second exemplary embodiment of the candle emulation device of FIG. 1A is shown with fragrance-release mechanism 150 optionally implemented within candle emulation device 100. Candle emulation device 100 is illustrated as a chandelier that comprises a frame 230 for supporting multiple light sources 235₁-235_{M} (M≧1), generally referred to as “light sources 235”. According to one embodiment, light sources 235 may be centrally controlled by light source controller 120 placed within an interior of frame 230 and routing power received from an external power source. However, according to another embodiment illustrated in FIG. 2C, each of the light sources 235 may be controlled in a decentralized fashion, where multiple light source controllers are placed within the housing of each corresponding light source 235₁, . . . , and 235_{M} or within frame 230 proximate to each corresponding light source 235₁, . . . , and 235_{M}.

Referring to FIG. 2D, a fourth exemplary embodiment of candle emulation device 100 of FIG. 1A is shown with fragrance-release mechanism 150 optionally implemented within candle emulation device 100. Configured as part of a single, removable light source 250, candle emulation device 100 comprises an Edison base 255 for rotational coupling to a lamp, desk light, sconce, or other lighting fixture. Candle emulation device 100 comprises light source controller 120, which is electrically coupled to both base 255 and incandescent bulb 220 and controls incandescent bulb 220 to provide a lighting effect that emulates a candle flame. It is contemplated that base 255 may be a small, medium or large Edison base, bi-pin base, or any other commonly used light bulb base, which might be adapted for use with candle emulation device 100.

Referring now to FIG. 3A, a first exemplary embodiment of a light source represented as an incandescent light bulb 220 featuring staggered electrical feedthroughs 320₁-320_{R} (R≧2) and operating as light source 110₁ for candle emulation device 100 of FIG. 1A is shown. When used with 120 VAC input power, for example, incandescent light bulb 220 might be configured with one or more 60-120 VAC filaments that are designed to operate at approximately 50/50 duty cycle (e.g., during only one-half wave of the AC power cycle) and are controlled to provide a stable, low wattage incandescent light to emulate lighting from a candle flame. Designing the filaments to a lower voltage allows the use of lower wattage filaments that are more mechanically stable and easier to manufacture.

Incandescent light bulb 220 comprises a bulb housing 300 made of glass or high temperature plastic that surrounds one or more filaments 340. Bulb housing 300 features a closed first end 305 and a second end 310 featuring an opening 312 through which multiple feedthroughs 320₁-320_{R} extend. Second end 310 of bulb housing 300 features an elongated protrusion 314 formed at a perimeter of opening 312 to create a channel 316. Channel 316 provides an interlocking mechanism for a base 330 as shown in FIG. 3B.

Each “feedthrough” 320₁-320_{R} is an electrical lead line extending from second end 310 and coupled to filament 340 within bulb housing 300. For this embodiment of the invention, four feedthroughs 320₁-320₄ are arranged in a staggered orientation with ends 322₁ and 322₃ of first and third feedthroughs 320₁ and 320₃ having a first curvature and ends 322₂ and 322₄ of second and fourth feedthroughs 320₂ and 320₄ having a second curvature. The second curvature may be in a direction consistent with or opposite from the first curvature as shown.

According to one embodiment of the invention, as shown in FIG. 3B, base 330 comprises first end 331 and a second end 333. First end 331 features a protrusion 332 that, when second end 310 of bulb 300 is inserted into base 330, interlocks with channel 316. Of course, it is contemplated that base 330 may be structured in a configuration other than a rectangular form factor, such as a generally circular configuration as shown in FIG. 3C.

Second end 333 of base 330 comprises a first plurality of grooves 334₁-334₄ alternatively positioned on a top and bottom surfaces 335 and 336 of base 330. A corresponding plurality of grooves 337₁-337₄, having a lesser width than first plurality of grooves 334₁-334₄, are alternatively positioned on bottom and top surfaces 336 and 335 of base 330. This alternative groove construction exposes multiple sides of ends 322₁-322₄ of feedthroughs 320₁-320₄ to increase contact area and enable polarizing of base 330. This increased contact area provides better connectivity with a corresponding connector for light source controller 120.

More specifically, as shown, each groove (e.g., groove 334₃) is offset from neighboring grooves 334₂ and 334₄ so that a first segment 324₃ of feedthrough 320₃ is exposed. A second segment 326₃ of feedthrough 320₂ is accessible within groove 337₃.

FIG. 3D is an exemplary embodiment of independently controlled, multi-filament incandescent light bulb 220 of FIG. 3A or 3C. Herein, four filament segments 342₁-342₄ are arranged in an electrically continuous polygon shape and are independently controlled through feedthroughs 320₁-320₄, respectively. It is contemplated that fewer or more than four segments may be arranged with a corresponding number of feedthroughs. These feedthroughs 320₁-320₄ are attached to intersection points A-D of filament segments 342₁-342₄. Filament segments 342₁-342₄ may be separate filaments or sections of a single filament.

According to one embodiment of the invention, each filament segment 342₁, . . . , or 342₄ is designed to operate at full brightness at 50% duty cycle. For example, filament segment 342₁ may be a 60 VAC filament that is operating at full power and 50/50 duty cycle (e.g., turned on for one-half wave of a 120 VAC power cycle for this embodiment). However, it is contemplated that other duty cycles may be used. For instance, opposite filament segments 342₁ and 342₃ (or 342₂ and 342₄) may be configured with different duty cycles summing to 100% duty cycle (e.g., filament segment 342₁ at 70% duty cycle and filament segment 342₁ at 30% duty cycle; filament segment 342₂ at 80% duty cycle and filament segment 342₄ at 20% duty cycle, etc.) or with collective duty cycles slightly exceeding 100% (e.g., filament segment 342₁ at 60% duty cycle and filament segment 342₁ at 60% duty cycle; filament segment 342₂ at 55% duty cycle and filament segment 342₄ at 60% duty cycle, etc.).

FIG. 3E is a first exemplary schematic diagram of a multi-filament incandescent bulb 220 of FIG. 3A or 3C with each of the four filament segments 342₁, . . . , and 342₄ independently controlled. Feedthroughs 320₁-320₄ are coupled at points of intersection for various filament segments; namely, intersection point A is between filament segments 342₁ and 342₄, intersection point B is between filament segments 342₁ and 342₂, intersection point C is between filament segments 342₂ and 342₃, and intersection point D is between filament segments 342₃ and 342₄.

According to this embodiment of the invention, one end of first filament segment 342₁ is coupled to receive input power (Vᵢₙ) when a first switching element 350 (e.g., p-channel transistor) is active (closed). The other end of first filament segment 342₁ is coupled to ground (GND) when a fourth switching element 353 (e.g., n-channel transistor) is active. Hence, first filament segment 342₁ is illuminated when switch input (\overline{A1}) is logic low and switch input B1 is logic high.

Similarly, a first end of second filament segment 342₂ is coupled to GND when fourth switching element 353 is active. A second end of second filament segment 342₂ is coupled to Vᵢₙ when a second switching element 351 (e.g., p-channel transistor) is active. This is accomplished when a switch input (\overline{A0}) is logic low and switch input B1 is logic high.

As further shown, a first end of third filament segment 342₃ is coupled to Vᵢₙ when second switching element 351 is active (closed). A second end of third filament segment 342₃ is coupled to GND when a third switching element 352 (e.g., n-channel transistor) is active. Hence, third filament segment 342₃ is illuminated when switch input (\overline{A0}) is logic low and switch input B0 is logic high.

In addition, a first end of fourth filament segment 342₄ is coupled to GND when third switching element 352 is active. A second end of fourth filament segment 342₄ is coupled to Vᵢₙ when first switching element 350 is active. This is accomplished when a switch input (\overline{A0}) is logic low and switch input B0 is logic high.

Hence, as shown in the operational table of FIG. 3E, each column represents a selected time portion of a power wave cycle that can be used for independent, pulse width modulation control of all filament segments 342₁-342₄. For instance, as an example, for input power (e.g., 110-220 volt input such as 110 VAC @ 60 Hz) at 50% duty cycle, filament segments 342₂ and/or 342₃ may operate at 50/50 duty cycle (e.g., powered during a first half of the power cycle) and filament segments 342₁ and/or 342₄ may operate at 50/50 duty cycle (e.g., powered during a second half of the power cycle).

For instance, for this embodiment, during the first half of the power cycle, filament segment 342₂ may be powered a certain percentage of the total cycle time and filament segment 342₃ may be powered a certain percentage, where these percentages do not have to be equal. Similarly, during the second half of the power cycle, filament segment 342₁ may be powered a certain percentage of the total cycle time and filament segment 342₄ may be powered a certain percentage, where these percentages also do not have to be equal. This results in independent, pulse width modulation controlled filament segments. Of course, it is contemplated that filament segments may operate at a different duty cycle instead of the particular 50/50 duty cycle described for illustrative purposes.

As yet another example, presume that input power (e.g., 110-220 VAC input voltage such as 110 VAC @ 60 Hz) is applied to light source controller 120 where a first set of filament segments (e.g., filament segments 342₂ and/or 342₃) operate at 70% duty cycle and a first set of filament segments (e.g., filament segments 342₁ and/or 342₄) operate at 30% duty cycle. During 70% of the power cycle, only filament segments 342₂ and/or 342₃ may be powered. During the remaining 30% of the cycle, filament segments 342₁ and/or 342₄ may be powered, where each filament segment of a set may not be powered equally. This provides different periods of illumination for different filament segments.

FIG. 3F is a second exemplary schematic diagram of a multi-filament incandescent bulb of FIG. 3A or 3C with two of the filament segments independently controlled. In contrast with the configuration of FIG. 3E, intersection point A between filament segments 342₁ and 342₄ and intersection point C between filament segments 342₂ and 342₃ are continuously coupled to input power (Vᵢₙ).

As shown, filament segments 342₁ and 342₂ are coupled in parallel and filament segments 342₃ and 342₄ are coupled in parallel. By activating SW3, SW4, or both, as shown in the operational table of FIG. 3F, each for some percentage of time, independent, pulse width modulation control of groups of filament segments is achieved, namely filament segments 342₁-342₂ and 342₃-342₄ respectively.

FIG. 3G is a third exemplary schematic diagram of a multi-filament incandescent bulb of FIG. 3A or 3C. As shown, filament segments 342₁ and 342₂ are in series and collectively in parallel with filament segments 342₃ and 342₄ which are also in series. This produces a light bulb that emulates lighting from a candle flame through PWM of power signals applied to filament segments 342₁-342₄, but may not have a shifting flame effect as set forth in FIGS. 3E and 3F.

In summary, the purpose of this multi-filament bulb structure is to provide a uniform replacement bulb for all types of fixtures. The electronics in the light source controller, namely the existence and control of the switching elements within driver circuitry of the light source controller, dictates the operability of the incandescent light bulb.

FIG. 3H is a fourth exemplary schematic diagram of a multi-filament incandescent bulb of FIG. 3A or 3C with each of the four filament segments independently controlled as described in FIG. 3E. Herein, four filament segments 342₁-342₄ are arranged in an electrically discontinuous polygon shape with no direct coupling of filament segments 342₁ and 342₄. Instead, separate ends 344 and 346 of filament segments 342₁ and 342₄ are coupled to feedthroughs 320₄ and 320₅, respectively. These feedthroughs 320₄ and 320₅ may be electrically coupled together outside bulb housing 300 of FIG. 3A or 3C, so that only four feedthroughs 320₁-320₄ are adapted to base 330.

FIG. 3I is a fifth exemplary schematic diagram of multi-filament incandescent bulb of FIG. 3A or 3C with a reduced number of electrical feedthroughs 320₂, 320₄ and 320₅. As shown, electrical feedthroughs 320₂ would be attached at intersection point C between filament segments 342₂ and 342₃. Electrical feedthroughs 320₄ would be coupled to end 344 of filament segment 342₁ while electrical feedthrough 320₅ would be coupled to end 346 of filament segment 342₄. Non-conductive supports 348 and 349 are arranged to support filament segments 342₁-342₄, where supports 348 and 349 differ from feedthroughs because they remain isolated within bulb housing 300 of FIG. 3A or 3C. These supports 348 and 349 may be made of electrically non-conductive material.

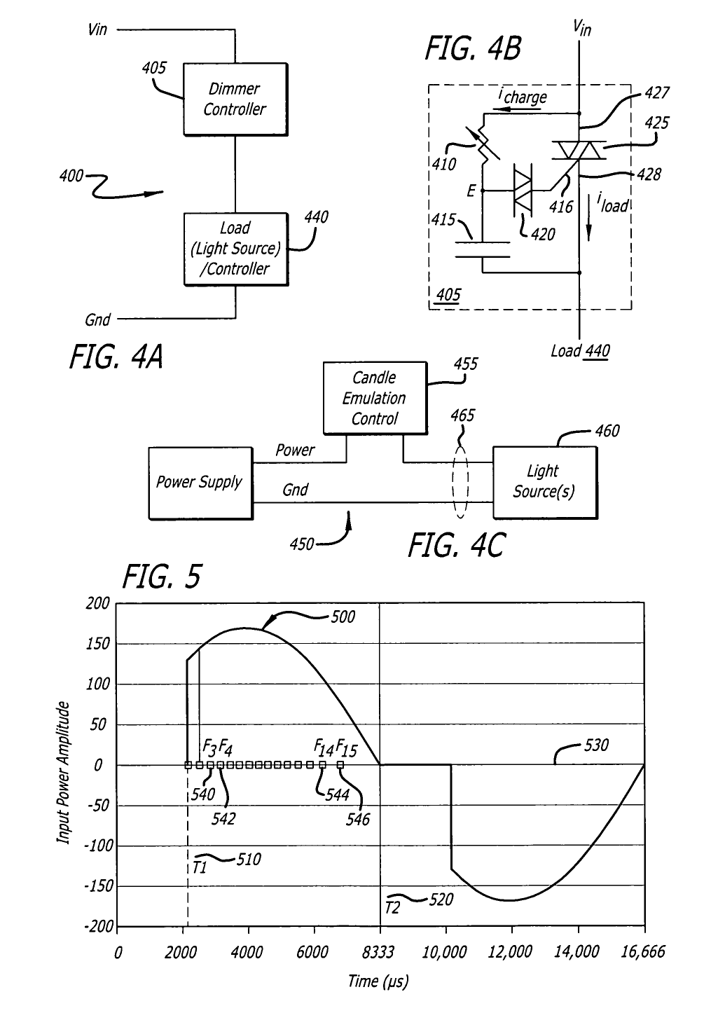

Referring now to FIG. 4A, an exemplary embodiment of a dimmer switch 400 featuring a dimmer controller 405 adapted to control a load 440, such as light source controller 120 and corresponding light source 110 of FIG. 1A for example, in order to emulate lighting from a candle flame. Dimmer controller 405 may have any number of topologies such as a delayed-fired triac architecture as shown in FIG. 4B, or architectures without a triac element such as a variac based wall dimmer and the like.

FIG. 4B is a first exemplary embodiment of the internal components forming dimmer controller 405 of FIG. 4A. According to this embodiment, dimmer controller 405 comprises a variable resistor 410, a capacitor 415, a diac component 420 and a triac component 425. As shown, variable resistor 410 is coupled to capacitor 415 at node E, creating a RC circuit. A first terminal 421 of diac component 420 is coupled to the RC circuit at node E while a second terminal 422 of diac component is coupled to a gate terminal 426 of triac component 425. The remaining terminals 427 and 428 of triac component 425 are coupled to input power (Vᵢₙ) and load 440 over a main power line, thereby allowing current (i_{load}) to flow to load 440 when gate terminal 426 is activated.

At start-up, triac component 425 is turned off so i_{load} is not flowing to load 440. Instead, a charging current (i_{charge}) flows through variable resistor 410 and charges capacitor 415. Once node E reaches a triggering voltage for diac component 420, diac component 420 goes low resistance and conducts, applying a pulse to gate terminal 426. As a result, triac component 425 is turned on to allow i_{load} flows to load 440.

Triac component 425 remains turned on until i_{load} falls below a minimum current threshold. For one embodiment of the invention, where Vᵢₙ is a phase controlled, time-varying power waveform such as AC power signal for example, at every zero crossing of the AC power signal, triac component 425 is turned off because i_{load} would diminish below a current threshold upon reaching the zero crossing and would not be turned on until later in the AC half-cycle.

FIG. 4C is a second exemplary embodiment of a dimmer switch 450 adapted with a candle emulation controller 455 coupled in series with one or more light sources 110 and controlling the light sources in order to emulate lighting produced from a candle flame. According to this embodiment, candle emulation controller 455 is logic combining the functionality of light source controller 120 with a dimmer controller.

For this example, candle emulation controller 455 is coupled in series between power supply 130 and light source 460 through pre-existing power lines 465. Candle emulation controller 455 could be placed into a single housing (not shown) that can be placed into an electrical box previously used by a conventional light switch. This embodiment differs from dimmer switch 400 of FIG. 4A due to the physical separation of the light source controller and light source 460. Herein, light source 460 could be a sconce, porch light or other light that is now controlled to emulate lighting from a candle flame using existing wiring from the electrical box and remotely placed from the light source controller.

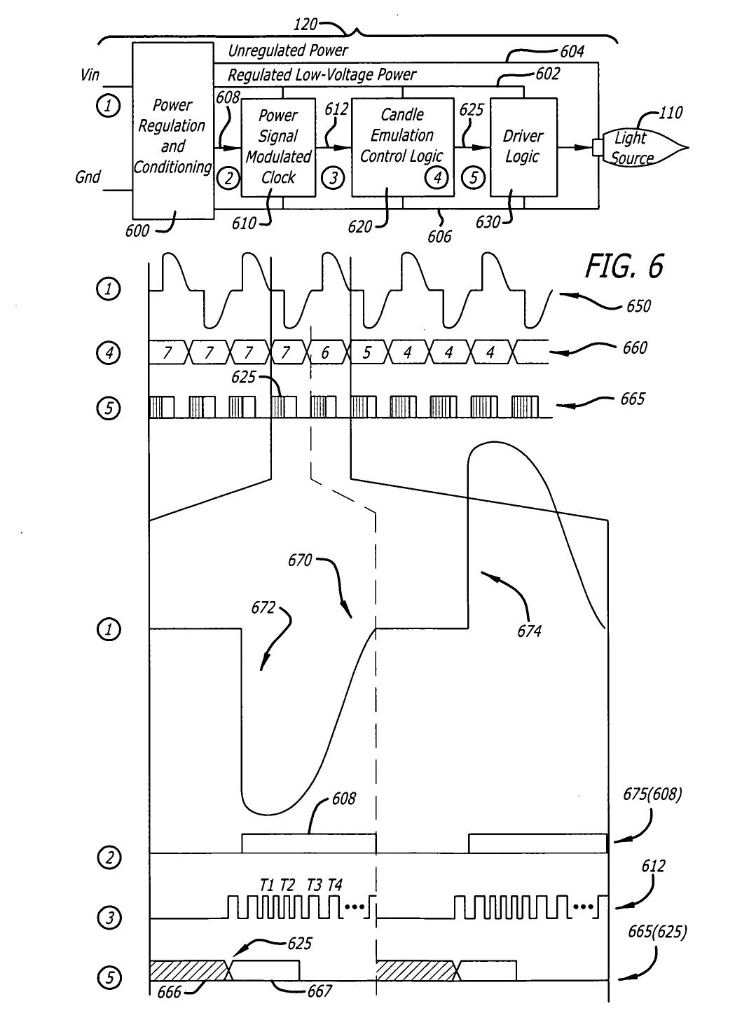

Referring to FIG. 5, an exemplary embodiment of a phase controlled, periodic power waveform (also generally referred to as an “input power waveform”) 500 supplied from dimmer switch 400 of FIG. 4A is shown. More specifically, for this embodiment, input power waveform 500 is based on a phase controlled, time-varying power waveform such as AC power signal (e.g., e.g., 110-220 volt input such as 110 VAC at 60 Hz). When the user raises or lowers the amount of dimming, the turn-on point of the power shifts back and forth, cutting off some amount of each half-wave of power. In theory, as shown, the voltage amplitude of input power waveform 500 supplied from the delayed-fired triac component is zero is when the RC circuit is charging. In practice, however, there may be a high impedance path through triac component 425 shown in FIG. 4B that would allow the input voltage to drift up toward Vᵢₙ if not pulled down with a resistor or other load. As long as the triac component is turned off, however, only a very small and specified amount of leakage current would flow through the triac component.

At T1 510 (e.g., approximately 2000 microseconds “μs”), the RC circuit has been charged to cause the diac component to turn on the triac component. The voltage amplitude of input power waveform 500 now matches Vᵢₙ. Thereafter, it continues to follow AC power signaling until T2 520 (e.g., 8333 μs), where the triac component would be turned off and the RC circuit would begin to recharge.

The data points (Fᵢ, where 1≦i≦15) computed along a time axis 530 illustrate equal area under input power signal 500, which represents equal slices of voltage that can be applied to a light source. For instance, the time difference between data points F₃ 540 and F₄ 542 is substantially less than the time difference between data points F₁₄ 544 and F₁₅ 546. The reason is that higher voltages are applied at F₃ 540 and F₄ 542 than F₁₄ 544 and F₁₅ 546. Thus, applying one fifteenth ( 1/15) of the total voltage to the load would require the light source to be turned on for the duration from F₃ 540 to F₄ 542 or from F₁₄ 544 and F₁₅ 546 for example.

Referring now to FIG. 6, an exemplary embodiment of light source controller 120 operating with a dimmer controller to control a light source in order to emulate lighting from a candle flame and signaling received and produced for a single filament is shown. Of course, other type light source controllers may be used. For instance, the light source controller may be a processor, microcontroller or any logic that controls the light source to emulate lighting from a candle flame.

As shown, for this embodiment of the invention, a single light source 110 is controlled by light source controller 120 that comprises power regulation and conditioning logic 600, a power signal modulated clock 610, candle emulation control logic 620 and driver logic 630. It is contemplated, however, that multiple sets of drivers and multiple sets of light sources may be controlled by candle emulation control logic 620, or alternatively, controlled by multiple candle emulation control logic units.

As shown, power regulation and conditioning logic 600 receives input power (Vᵢₙ) 650 and ground (GND). Vᵢₙ 650 may be DC power or AC power at any selected duty cycle such as seventy-five percent (75%) as shown. Power regulation and conditioning logic 600 produces both a regulated low voltage power 602 (e.g., 5V, 12V, etc.) and an unregulated voltage power 604, and supplies GND signaling through ground lines 606. Regulated low voltage power 602 is supplied to components of light source controller 120, namely power signal modulated clock 610, candle emulation control logic 620 and driver logic 630. Unregulated voltage power 604 is supplied to light source 110 in order to avoid supplying a substantial amount of regulated voltage to power a high wattage light source such as a 60 W or 100 W incandescent light bulb. Unregulated power 604 may be filtered and/or even a rectified version of Vᵢₙ 650.

Power signal modulated clock 610 receives a control signal 608 from power regulation and conditioning logic 600 that provides information on the timing of the turn-on and turn-off points of triac component 425 for dimmer switch 400 of FIG. 4B. In other words, power signal modulated clock 610 produces a clock 612 that is applied to candle emulation control logic 620 based on information pertaining to Vᵢₙ 650, the input power waveform.

Candle emulation control logic 620 receives clock 612 and outputs pulse width modulated (PWM) signals 625 to driver logic 630. These PWM signals 625 activate and deactivate components of driver logic 630 in order to control light source 110 to emulate lighting from a candle flame. For this embodiment of the invention, candle emulation control logic 620 is outputting values at 50/50 duty cycle such as every half power cycle at 120 HZ if Vᵢₙ is 60 HZ AC power for example. Examples of candle emulation control logic 620 include, but are not limited to an application specific integrated circuit (ASIC), a programmable processor or controller (e.g., microcontroller), a field programmable gate array, combinatorial logic or the like.

For this embodiment of the invention, driver logic 630 is configured with switching hardware such as metal-oxcide semiconductor field-effect transistors (MOSFETs), triac components, bipolar junction transistors, or the like. Regardless of the circuitry deployed, the switching hardware is configured to activate and deactivate the load (e.g., various filaments) of the light source.

As further shown in FIG. 6, exemplary embodiments of the signaling received and produced by light source controller 120 are shown. As illustrated, a first waveform 650 illustrates the phase controlled, time-varying, input power waveform (Vᵢₙ) that, for this embodiment, is a resultant periodic AC (60 Hz) power signal produced by a delay-fire triac component 425 of FIG. 4B of dimmer switch 400. Although not shown, input power waveform (Vᵢₙ) may be a modulated power waveform with a high frequency carrier with appropriate amplitude modulation with polarity switching as produced by electronic transformers. As an example, the carrier would be a high frequency signal and the baseband signal would be first waveform 650.

As further shown, a second waveform 660 illustrates the values being produced internally by candle emulation control logic 620. More specifically, candle emulation control logic 620 receives clock 612 from power signal modulated clock 610 and produces values, which differ or are equal in width every power half-cycle of the input power waveform (e.g., at 120 Hz). These values are used to identify a particular amount of voltage applied to the load. For instance, where a power half-cycle constitutes fifteen (15) time slices, the value “7” indicates that 7/15 of the voltage available is applied to the load.

A third waveform 665 is the actual value being multiple PWM signals 625 output to driver logic 630 of FIG. 6. Herein, waveform 665 is active-high, and thus, components of driver logic 630 are activated when waveform 665 is logic high and are deactivated when waveform 665 is logic low.

As still shown in FIG. 6, a detailed perspective of a power cycle of input power waveform (Vᵢₙ) and certain resultant signals produced by components of light source controller 120 are shown. For instance, waveform 670 is a detailed illustration of a single power cycle of first waveform 650 having a first power half-cycle 672 and a second power half-cycle 674.

A waveform 675 is representative of control signal 608 from power regulation and conditioning logic 600 that provides information on the timing of the turn-on and turn-off points of the dimmer switch's triac component. It is contemplated that waveform 675 may have an analog format. Waveform 675 merely provides information to power signal modulated clock 610 regarding Vᵢₙ such as when is power being turned on and turned off, how much power is available at a certain time, and the like.

A portion of clock 612 generated by power signal modulated clock 610 is further shown. The purpose of clock 612 is to clock candle emulation control logic 620 in such a way that the varying input voltage is being adjusted for terms of the time that the output is activated.

Herein, the periodicity of clock 612 is varied based on the input power waveform 670. More specifically, clock 612 is frequency modulated by input power waveform 670 such that clock 612 experiences a higher frequency when input power waveform 670 has a higher amplitude, and experiences a lower frequency when input power waveform 670 has lower amplitude. In other words, clock 612 is more compressed the higher the voltage amplitude of input power waveform 670.

For this illustrative embodiment, the clock pulse widths at time T1 and T2 are substantially narrower than the clock pulse widths at times T3 and T4. In other words, the periods of the clock cycles vary. It is noted that, for one embodiment of power signal modulated clock 610, a predetermined number of clock pulses (e.g., approximately 240 clock pulses) are provided for each power half-cycle 672 or 674. For each power half-cycle, candle emulation control logic 620 outputs a series of PWM output signals (referred to as “PWM frame”), and thus, by altering the clock pulses, the PWM output signals may be adjusted accordingly.

A more detailed illustration of a portion of third waveform 665 is shown. This portion illustrates the actual output to driver logic 630 where, in a first region 666 of waveform 665, the triac component 425 in the dimmer switch is not activated. However, driver logic 630 continues to receive power and continue to charge the RC circuit in the dimmer switch. As soon triac component 425 is set as shown in region 667, candle emulation control logic 620 waits for a programmed time period (e.g., 7/15 of power half-cycle) until light source 110 is to be turned off. At that time, power is turned off and an appropriate amount of time is waited until the power is turned on (e.g., around zero-crossing of input power waveform 670) so that the RC circuit is allowed to operate correctly.

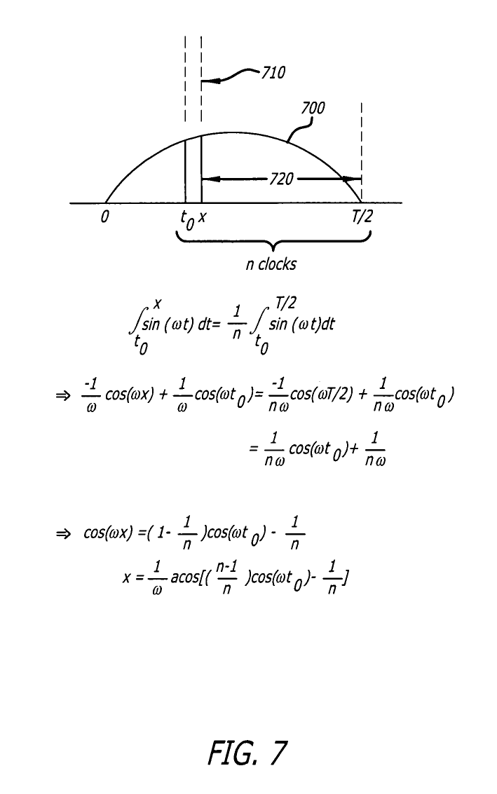

FIG. 7 is an exemplary embodiment of the operations performed by power signal modulated clock 610 of FIG. 6. This embodiment involves computing time-varying clock periods at approximately 50/50 duty cycle, such as over each half-cycle of input power waveform 700 (Sin(ωt)) as illustrated therein. Of course, estimation and use of tables rather than iterative computations may simplify the computations.

At start time (t₀), a time when the dimmer switch turns on or certain number of clocks after, “n” clocks need to be provided before the end of the power half-cycle (T/2). The period 710 of the next clock pulse is set to be equal to the difference of “x” (to be computed) and t₀.

Therefore, an integral is taken from time t₀ to time “x” of input power waveform (Sin(ωt)) 700 and it is set equal to one-n^{th} of the full amount of remaining power 720 that is remaining, being the power of the half-cycle from time t₀ to time “T/2”. Hereafter, time “x” is computed and this iterative process is used to compute the period of the next clock pulse. Of course, tables may be used to provide estimated values in order to reduce the computational intensity required by power signal modulated clock 610 of FIG. 6.

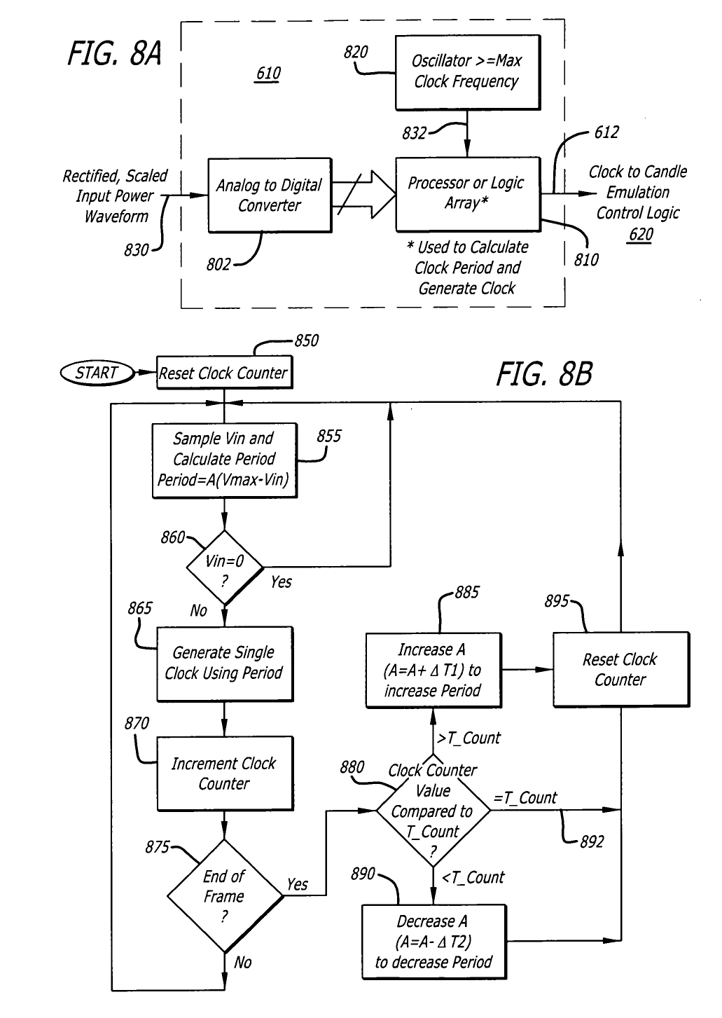

FIG. 8A is an exemplary embodiment of components implemented within power signal modulated clock 610 of FIG. 6. Power signal modulated clock 610 comprises an analog-to-digital (A/D) converter 800, processing logic 810 and an optional oscillator 820. Herein, A/D converter 800 receives a rectified, scaled input power waveform 830 and measures the amount of voltage associated therewith. Based on the measured voltage levels of power waveform 830, processing logic 810 computes clock 612, which is a frequency modulated clock signal formed as a collective of clock pulses varying in time so that each clock period is associated with a substantial equal amount of measured voltage of input power waveform 830. As an optional feature, oscillator 820 is adapted to provide a base clock 832 to processing logic 810, where base clock 832 would oscillate at a frequency greater than the maximum clock frequency of clock 612. It is contemplated, of course, that processing logic 810 may be asynchronous logic, thereby not requiring any external clocking signals from oscillator 820.

Referring now to FIG. 8B, a second exemplary embodiment of the operations performed by power signal modulated clock 610 of FIGS. 6 and 8A is shown. For this embodiment, “Vᵢₙ” is considered to be an input AC power waveform that is used to produce a frequency modulated clock signal.

Initially, a clock counter is reset and Vᵢₙ is sampled to calculate a new period (PERIOD) according to Equation 1 (see blocks 850 and 855):

Equation 1:
PERIOD=A(Vₘₐₓ−Vᵢₙ), where
“A” is a predetermined amplitude;
“Vₘₐₓ” is a maximum voltage for the input power waveform; and
“Vᵢₙ” is the sampled voltage of the input power waveform.

For this illustrative embodiment, as shown in block 860, a determination is made whether Vᵢₙ is a non-zero value (or alternatively reaches a predetermined minimum threshold voltage where Vᵢₙ≧|Vₘᵢₙ|). If so, a single clock is generated using the predetermined clock period and the clock counter is incremented (blocks 865 and 870). Otherwise, a wait state occurs and Vᵢₙ is measured again.

Next, a determination is made whether Vᵢₙ has fallen below a minimum voltage threshold (Vᵢₙ<|Vₘᵢₙ|). “Vₘᵢₙ” may be a programmable value or a preset, static value. As an example, where Vᵢₙ is a 110 volts (@60 Hz) power waveform, Vₘᵢₙ may be set at five (5) volts for example. As another example, Vᵢₙ is any power waveform based on any voltage, most likely ranging between 110-220 volts in accordance with U.S. and International standards. The purpose of this determination is to detect an end of PWM frame (block 875).

In the event that an end of the PWM frame has not been detected, Vᵢₙ is sampled and a new period (PERIOD) is calculated according to Equation 1 above. As a result, successive clock signals for the PWM frame are frequency modulated based on the measured voltage of Vᵢₙ.

In the event that an end of the PWM frame is detected, the count value is compared to a predetermined targeted count value (T_COUNT) as shown in block 880. If the count value is greater than T_COUNT, the period of the power cycle is increased by a first amount of time (ΔT1) as shown in block 885. In contrast, if the count value is less than T_COUNT, the period of the power cycle is decreased by a second amount of time (ΔT2), where ΔT1 may or may not be equal to ΔT2 (block 890). If the count value is equal to T_COUNT, the period remains unchanged (block 892). For all of these determinations, the method of operation returns to block 855 after the clock counter is reset and the beginning of a new power cycle is monitored.

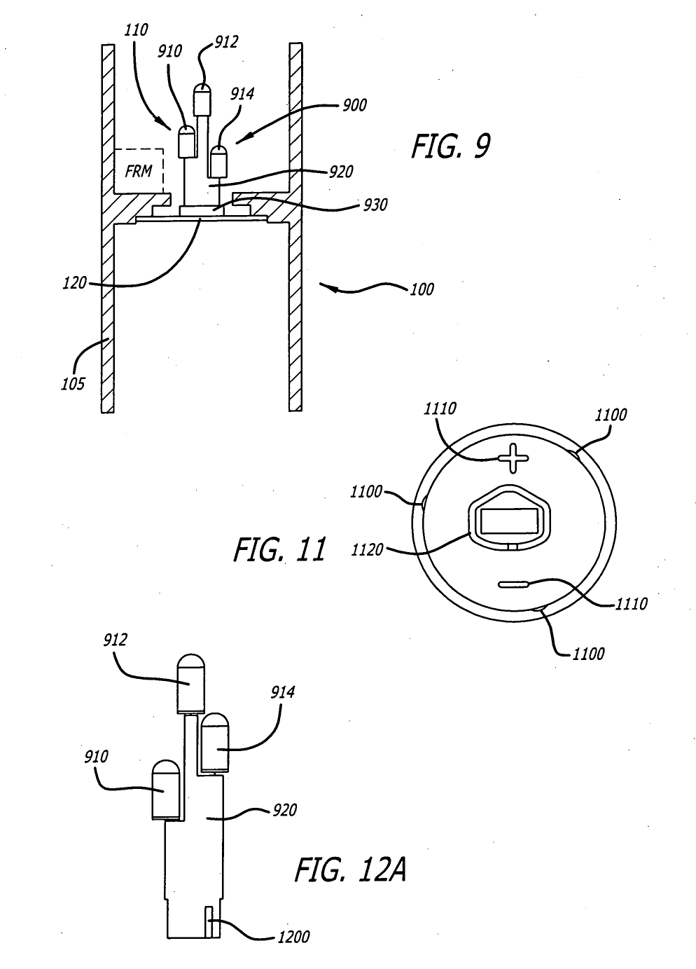

Referring now to FIG. 9, a cross-sectional view of a fifth exemplary embodiment of candle emulation device 100 is shown with a first alternative embodiment of light source 110 and fragrance-release mechanism 150 optionally implemented therein represented by dashed lines. According to this embodiment of the invention, contained within housing 105, light source 110 comprises an assembly 900 that includes three lighting elements such as T1 size 12V 80-100 milliamperes (mA) incandescent bulbs 910, 912 and 914. Of course, in lieu of incandescent bulbs, it is contemplated that light source 110 may be implemented with other types of lighting elements such as light emitting diodes (LEDs) as described below, incandescent bulbs having different power and current demands such as low voltage (5V or less) 55-80 mA bulbs, or any other appropriate lighting source that can be controlled by light source controller 120. Such control may involve pulse width modulation or power limited and controlled via some other method may be used.

Besides the above-described lighting elements, assembly 900 further comprises a separate, auxiliary printed circuit board (PCB) 920 that is adapted and oriented in substantially perpendicular position when coupled to the light source controller 120 of FIG. 1A via an edge connector 930. According to one embodiment of the invention, lighting elements 910, 914 and 912 are at a height of approximately one-quarter of an inch (¼″), ½″, and ¾″ from edge connector 930 of PCB 920 and the total length of auxiliary PCB 920 being approximately 1″. According to another embodiment, two or more of lighting elements 910, 912 and 914 may be positioned at the same height.

Of course, assembly may have other embodiments. For instance, it is contemplated that lighting elements 910, 912 and 914 could be soldered directly to a printed circuit board of light source controller 120 in either a vertical or horizontal orientation or connected via wires of some length. As an example, assembly 900 may be adapted with a plurality of electrical lead lines each including a LED coupled at one end and the other end coupled to the PCB featuring light source controller 120. The lead lines may be protected by a sleeve housing, which surrounds and covers at least a portion of the surface of the lead lines. No PCB 920 would be required.

It is further contemplated that an effect could be created using any number of light sources, especially when placed in at different heights or in different planes or when using lighting sources of different colors.

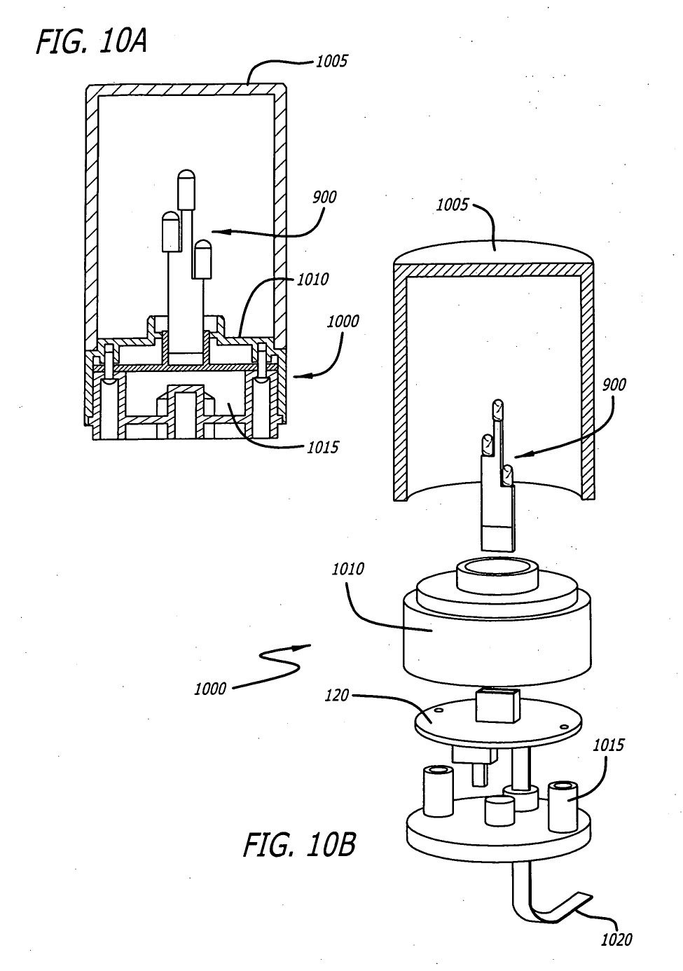

FIGS. 10A and 10B illustrate exemplary embodiments of an assembly of a votive being a type of candle emulation device and containing electronics and lighting elements necessary for creating a flickering candle effect. FIG. 10A illustrates a cross-sectional view of an embodiment of a fully assembled votive 1000 while FIG. 10B illustrates an exploded view of votive 1000 of FIG. 10A.

According to one embodiment of the invention, votive 1000 comprises a cover 1005, a housing top 1010, and a housing bottom 1015 as well as assembly 900 and light source controller described in FIG. 9.

Cover 1005 is a translucent covering that may or may not be frosted or textured to have effect on the emerging light. One feature of cover 1005 is to diffuse, color, or modify light and to protect circuitry from weather or moisture. In addition, cover 1005 is adapted to hide the light source from view of the user, and/or to create the effect of a candle burning inside a glass or plastic “votive” cup.

Housing top 1010 is designed to cover light source controller 120, and to create a removable mechanical contact with cover 1005. Optionally, housing top 1010 creates a water resistant or water proof seal with assembly 900 of FIG. 9.

Housing bottom 1015 is designed to cover and protect light source controller 120 and to provide mounting bosses underneath for mounting to lamps, lanterns or other housings or surfaces. Housing bottom 1015 also provides wire retention channels that hold and direct power wire 1020 exiting through holes in housing bottom 1015.

Assembly 900 comprises a small auxiliary printed circuit board 920 and one or more lighting elements 910, 912 and 914 as described in FIG. 9. In this illustrated embodiment, incandescent T1 sized light bulbs are used as lighting elements 910, 912 and 914. Lighting elements 910, 912 and 914 are placed at several heights to separate the sources of light in space to produce the appearance of movement of a flame when lighting elements 910, 912 and 914 are independently pulse width modulated or otherwise controlled.

It is contemplated that assembly 900 could be replaced with the light source as shown in FIG. 3D or 3I with the lighting of one or more filaments adjusted to emulate a lighting effect produced by a candle flame. Alternatively, assembly 900 may be substituted with a plurality of electrical lead lines and corresponding LEDs and or other lighting sources that are controlled by light source controller 120 to emulate the lighting effect of a candle flame.

Light source controller 120 is responsible for the pulse width modulation or other control of the light source such as assembly 900 featuring incandescent light bulbs or LEDs or the multi-filament incandescent light bulb of FIGS. 3A-3B, 3D and 3I. In general, according to this embodiment of the invention, light source controller 120 comprises power regulation and conditioning logic, candle emulation control logic to create realistic flickering of light sources (ELC001/ELC002), driver logic for bulbs/LEDs/light sources, and perhaps a switch or switches to control or modify the operation of such the above-identified logic.

It is contemplated that a “Tea light” may be provided as a separate component, where the Tea light utilizes the same general construction as votive 1000 except for cover 1005 described above. More specifically, Tea light comprises at least assembly 900 in communication with and controlled by light source controller 120 as shown in FIG. 9.

Referring to FIG. 11, an exemplary embodiment of a detailed view of housing 1010 of votive 1000 is shown. Of course, it is contemplated that the Tea light would have the same general constructions except for the connections between cover 1005 and housing top 1010. For instance, cover 1005 may make a mechanical connection to housing top 1010 via small bumps 1100 that lock into a complementary channel (not shown) in cover 1005 of FIG. 10B. Alternatively, housing top 1010 and cover 1005 may be attached together via some keying, twisting motion, screwing motion, tabs and slots, or other means of removable mechanical connection. Housing top 1010 is shown to have polarity markings 1110 on a top surface 1115 and on opposite sides of socket 1120 that is adapted to receive edge contacts of PCB 920 of FIG. 9. This aids the user in orienting or replacing assembly 900 of FIG. 9 or the multi-filament incandescent bulb set forth in FIGS. 3A-3B, 3D and 3I.

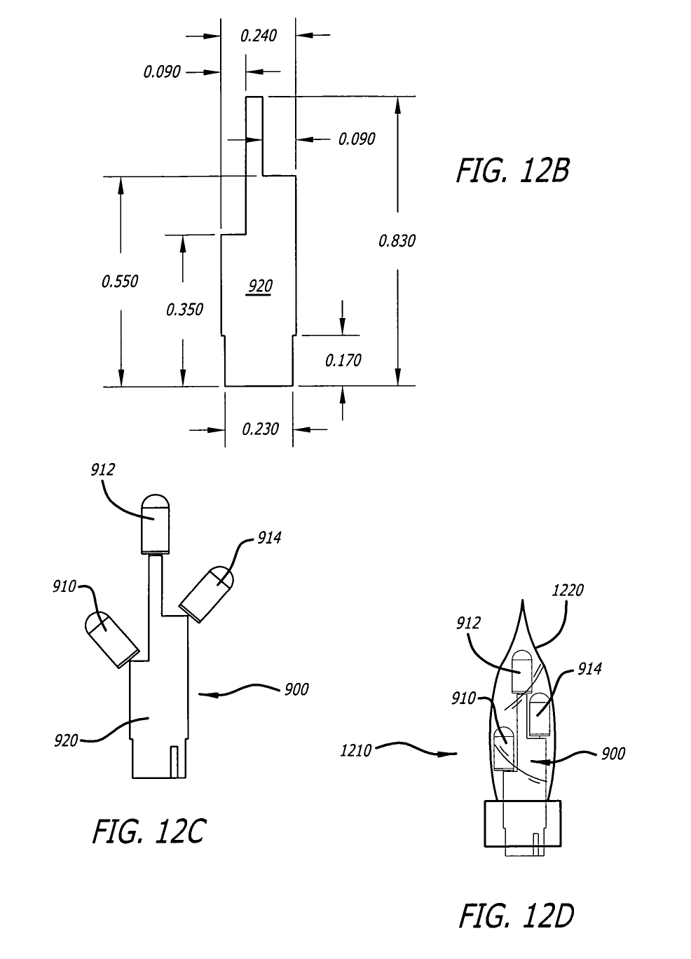

Referring now to FIGS. 12A and 12B, an exemplary embodiment of assembly 900 of FIGS. 9, 10A and 10B is shown. The drawing is in 3:1 scale and a length of PCB 920 is approximately 25 millimeters (mm) and the width is approximately 6 mm. In this embodiment of the invention, three incandescent bulbs 910, 912 and 914 are placed on auxiliary PCB 920 at various heights (or different distances from a contact edge) to create points of light separated in space. When pulse width modulated or otherwise controlled in an appropriate pattern, this arrangement produces a realistic moving and flickering light source that emulates a burning flame. It is envisioned that other light sources may be used including LEDs, etc. as described above.

It is contemplated that lighting elements 910, 912 and 914 may alternatively be angled away from the auxiliary PCB 920 at the top to further separate them in space. As shown in FIG. 12C, lighting elements 910 and 914 are angled away from lighting element 912 in order to spread out and maximize the distance between lighting elements. This creates a more dramatic shifting of light as each lighting element is dimmed or brightened.

Referring back to FIGS. 12A and 12B, auxiliary PCB 920 is made out of 1 mm FR4 Fiberglass material with gold plated edge contacts 1200 situated at the contact edge. It is envisioned that this arrangement of bulbs could be included on a single PCB by including some or all the electronics of light source controller on auxiliary PCB 920, in lieu of the collective operations. This single PCB solution would be adapted to achieve a desired result such as lower cost or a different form factor.

Referring to FIG. 12D, an alternative embodiment of an assembly 1210 adapted for a candle emulation device such as a Tea light is shown. In this embodiment of the invention, the same or similar PCB used in assembly 900 of FIG. 9 is coated, encased, or otherwise covered in a translucent material 1220 to protect it from moisture and mechanical damage. As an example, material 1220 is Dow Sylgard® 184/182 Silicone. The silicone is molded so that it not only protects lighting elements 910, 912 and 914 from moisture and mechanical damage, but the flexible silicone material also provides a seal with whatever electronics housing it is plugged into.

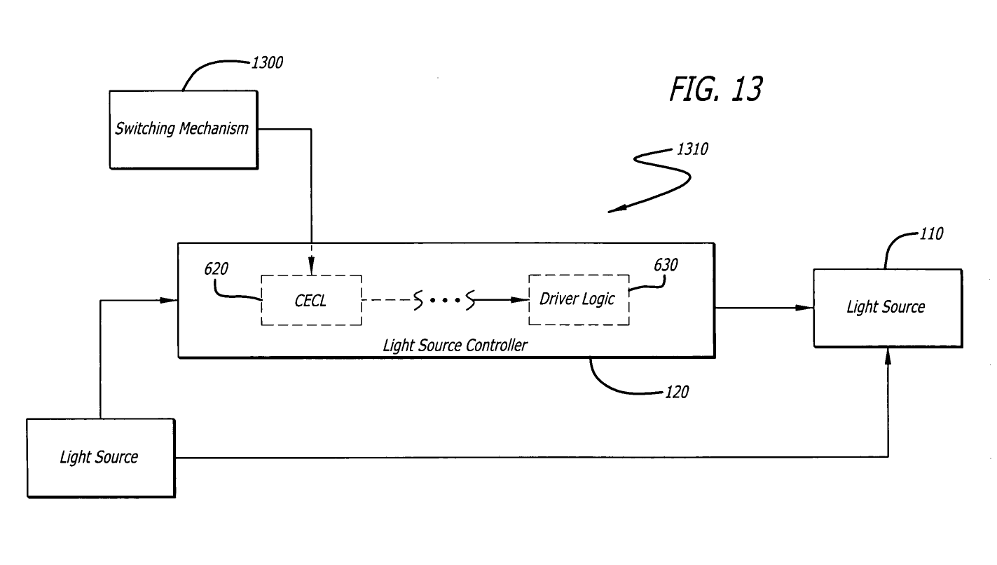

FIG. 13 is an exemplary block diagram illustrating mode switching at least partially controlled by light source controller 120 of FIG. 1A. Light source controller 120 is adapted to place light source 110 in a variety of lighting modes. As described above in detail, light source 110 may include a multi-filament incandescent bulb, an assembly featuring at least three incandescent bulbs, an assembly featuring at least three LEDs or the like. These lighting modes may include, but are not limited or restricted to one or more candle modes and/or one or more non-candle modes. Of course, it is contemplated that light source controller 120 may have a single mode of operation with multiple sub-modes as described.

In general, a “first mode” (non-candle mode) involves substantially constant illumination, which is the typical lighting effect produced by lighting fixtures using incandescent light bulbs (i.e. constant lighting). The first mode may have one or more sub-modes, each of which represents different illumination levels (dim/brightness levels), which may be useful for dimmer application or power savings.

A “second mode” (candle mode) is a mode of operation that emulates the lighting effect produced by a candle flame. More specifically, the second mode may also include one or more sub-modes, each representing a different type of lighting pattern produced by a candle flame. For instance, various candle (emulation) sub-modes may produce lighting patterns representing a glowing lighting effect, a flickering lighting effect (e.g., windy—candle in high wind with increased flickering rate; calm—candle in low wind with minimal flickering rate, etc.), a random lighting effect, a pulsating lighting effect where the light intensity routinely changes dramatically, a shifting effect where the physical location of the light appears to vary, or the like. It is contemplated that lighting modes and sub-modes described herein are merely illustrative, and not restrictive. Other lighting modes and sub-modes may be utilized by the invention.

The placement of light source controller 120 into a first mode or a second mode may be controlled by a switching mechanism 1300 accessible to the consumer. Examples of switching mechanism 1300 may include, but are not limited or restricted to a dimmer/light switch, a separate manual switch, a remote control or the like. For instance, the separate manual switch may be located on the housing of a lighting fixture (e.g., candle emulation device) 1310 that is implemented with light source controller 120. A consumer manually adjusts switching mechanism 1300 to signal candle emulation control logic (CECL) 620 of light source controller 120 as to the desired lighting mode.

For instance, switching mechanism 1300, when implemented as a light switch, may be turned on/off, perhaps multiple times, in order to program a default lighting mode, and/or place light source 110 into a particular lighting mode. The programming of the default lighting mode may be to any available lighting mode, regardless of the lighting mode that was previously used.

Based on the chosen setting of switching mechanism 1300 corresponding to a chosen mode of operation, CECL 620 generates a particular sequence of values that are subsequently used by CECL 620 as shown or perhaps power signal compensation logic of FIG. 9, to produce PWM output signals applied to driver logic 630. These PWM output signals are used to control activation and deactivation of filament segment(s) of light source 110, which produces the selected lighting effect.

Alternatively, switching mechanism 1300 may control placement of light source controller 120 into a first mode or second mode by a cyclical setting of the lighting modes. For instance, lighting fixture 1310 operates in a first mode and, upon an occurrence of a mode-switching event, lighting fixture 1310 may be configured to operate in another mode or a particular sub-mode. As an example, upon re-occurrence of a mode-switching event, candle emulation device 1310, previously operating in a first mode, now operates in a second sub-mode of the second mode. Hence, the selection of the lighting modes is performed serially and is dependent on either the prior lighting mode used or a selected default lighting mode (where a consumer selects how a light should respond whenever it is turned on from being off for a short amount of time).

Herein, a “mode-switching event” is any action that causes a change of state from one lighting mode to another. For instance, manual adjustment of a switch or dial associated with lighting modes placed on candle emulation device 1310 constitutes a mode-switching event. Additionally, pushing a button placed on lighting fixture 1310 to sequentially alter the lighting mode constitutes a mode-switching event. As another example, causing an interrupt in power (turning off/on a lighting fixture within selected period of time, or lowering the duty cycle of a dimmed input power wave to a certain threshold, followed by raising it) constitutes a mode-switching event. Also, control signaling from external control logic or even a solar cell, as X10 signaling over power line, or RF signal over air constitutes a mode-switching event.

Although not shown, it is further contemplated that a single light source (e.g., light source 110 of FIG. 1A) may be controlled by both light source controller 120 when candle emulation is desired or by other components when normal incandescent lighting (i.e., substantially constant illumination) is desired. More specifically, implemented within a lighting fixture, switching logic may be configured to support three or more operational states. A first state is an OFF state where light source 110 is not illuminated. The switching logic may be placed in a second state where a light source controller (as described above) is adapted to control the mode of operation of light source 110 in order to emulate the lighting effect produced by a candle flame. In addition, the switching logic may be placed in a third state where power is directly supplied to light source 110 bypassing the light source controller. In the third state, the light source provides substantially constant illumination. The switching logic would be controlled and placed into one of these operational states through use of a switching mechanism as described above.

Also, it is further contemplated that multiple light sources within a single lighting fixture may be separately controlled by a light source controller (defined above) and other components that are adapted to control and enable substantially constant illumination. For this configuration, one or more switches (located internally within the lighting fixture and/or externally within a wiring scheme) support three operational states. A first state is an OFF state where neither of the light sources is illuminated. A second state is where the light source controller is allowed to control the mode of operation of a first light source in order to emulate the lighting effect produced by a candle flame. Finally, a third state supplies power to enable substantially constant illumination of a second light source. Hence, when the lighting fixture is operational, the switch is controlled so that either the first light source provides illumination that emulates the lighting effect of a candle flame or the second light source provides substantially constant illumination (normal incandescent lighting).

While the invention has been described in terms of several embodiments, the invention should not be limited to only those embodiments described, but can be practiced with modification and alteration within the spirit and scope of the appended claims. The description is thus to be regarded as illustrative instead of limiting.

What is claimed is:

1. A candle emulation device comprising:
a light source;
a light source controller coupled to the light source, the light source controller to control the light source in order to produce a lighting effect that emulates lighting from a candle flame; and
a fragrance-release mechanism to release a fragrance into air surrounding the candle emulation device.

2. The candle emulation device of claim 1, wherein the light source is an assembly including a plurality of lighting elements controlled by the light source controller.

3. The candle emulation device of claim 2, wherein the plurality of lighting elements of the assembly corresponds to three incandescent light bulbs oriented at different heights from each other.

4. The candle emulation device of claim 2, wherein the plurality of lighting elements include a first lighting element and a second lighting element angled away from a third lighting element interposed between the first lighting element and the second lighting element.

5. The candle emulation device of claim 2, wherein the light source includes a printed circuit board coupled to the plurality of lighting elements and oriented to be substantially perpendicular to the light source controller when coupled to the light source controller.

6. The candle emulation device of claim 1, wherein the fragrance-release mechanism including a removable cartridge including material having the fragrance.

7. The candle emulation device of claim 6, wherein the removable cartridge of the fragrance-release mechanism is a container filled with a liquid having the fragrance.

8. The candle emulation device of claim 1 further comprising a housing including a plurality of translucent side walls and an opening through which the fragrance is released.

9. The candle emulation device of claim 1 further comprising a rotational base that increasing a size of the opening with a larger sized opening that releases a greater amount of fragrance.

10. The candle emulation device of claim 1, wherein the light source controller is adapted to place the light source into a first mode where the lighting effect emulates lighting from a candle flame and a second mode where the light source has substantially constant illumination.

11. The candle emulation device of claim 1 further comprising a rechargeable power source at least coupled to the light source controller.

12. A candle emulation device comprising:
a light source including at least three lighting elements; and
a light source controller adapted to control the at least three lighting elements of the light source to cause the at least three lighting elements to emulate lighting from a candle flame.

13. The candle emulation device of claim 1, wherein the light source further comprises a printed circuit board coupled to the at least three lighting elements and oriented to be substantially perpendicular to the light source controller when coupled to the light source controller.

14. The candle emulation device of claim 12, wherein the at least three lighting elements correspond to at least three incandescent light bulbs oriented at different heights from each other.

15. The candle emulation device of claim 12, wherein the plurality of lighting elements include a first lighting element and a second lighting element angled away from a third lighting element that is interposed between the first lighting element and the second lighting element.

16. The candle emulation device of claim 12 further comprising a fragrance-release mechanism to release a fragrance within an environment surrounding the candle emulation device.

17. The candle emulation device of claim 12, wherein the light source controller is adapted to place the light source in one of a plurality of lighting modes including a first mode where the light source emulates a selected type of lighting pattern representative of lighting effects produced by a candle flame and a second mode differing from the first mode.

18. An apparatus comprising:
a housing;
a light source placed within the housing;
a light source controller placed within the housing and adapted to place the light source in one of a plurality of lighting modes including a first mode where the light source is controlled to emulate a first type of lighting pattern representative of lighting effects produced by a candle flame and a second mode where the light source is controlled to emulate a second type of lighting pattern being different from the first type of lighting pattern; and
a fragrance-release mechanism to release a fragrance with an environment including the candle emulation device.

19. The apparatus of claim 18, wherein the light source controller places the light source into the second mode where the second type of lighting pattern is substantially constant illumination.

20. The apparatus of claim 18, wherein the light source controller places the light source into the second mode where the second type of lighting pattern emulates a lighting effect produced by a candle flame having a flickering rate different than a flickering rate of the first type of lighting pattern.
